(19) United States
(12) Patent Application Publication
(10) Pub. No.: US 2002/0075318 A1
(43) Pub. Date: Jun. 20, 2002

(54) System and method for providing adaptive scaling of selected features in an integrated receiver decoder

(76) Inventors: Hong Yang, San Diego, CA (US); Jenny Su Chow, San Diego, CA (US)

Correspondence Address: Andrea Petit-Clair, Sony Electronics, Inc., Intellectual Property Department, 123 Tice Blvd., Mail Drop T1-1, Woodcliff Lake, NJ, 07675, US

(21) Appl. No.: 09/747,253

(22) Filed: Dec. 20, 2000

(51) Int. Cl. G06F 3/14

(52) U.S. Cl. 345/810; 345/835

(57) ABSTRACT

The present invention relates to a home entertainment system and method for providing adaptive scaling of selected features on a screen page displayed by an entertainment system. The entertainment systems receives programming data associated with a show, and displays the programming data on a screen page. The user is then prompted to select at least one feature of the screen page for scaling and to provide a scaling factor of the at least one feature. Various embodiments are disclosed.

### BACKGROUND OF THE INVENTION

1. Field of the Invention

The present invention relates to a system and method for providing adaptive scaling of selected features in an electronic guide screen provided on a digital satellite system.

2. Description of Art Related to the Invention

In recent years, there has been a increasing demand for entertainment systems working in conjunction with various types of broadcasting systems. One type of entertainment system includes a broadcast satellite system; namely, a digital satellite system (DSS). Normally, a DSS comprises an antenna, an integrated receiver decoder (IRD) and a television receiver (TV). Also, the DSS may include an analog video cassette recorder (VCR) to receive analog data for recording purposes. The operations of the IRD are controlled by a remote control.

The antenna receives and routes digital bit streams to the IRD. Typically, a digital bit stream includes sensory data (e.g., video and/or audio) and programming data for one or more shows. The programming data is periodically updated and stored within the IRD and the prior programming data is erased (e.g., deleted, overwritten, etc.). Upon receiving a first command from the remote control, the IRD generates an “electronic guide screen” displaying programming data for each show capable of being received by the DSS.

The electronic programming guide screen typically includes a graphical portion and/or a text portion which provides information regarding a show. The text portion may, for example, include the program title, program rating, start time, and a general description of the show. The text portion may also include the schedule of various programs. In each of the above cases, the text displayed is typically of a small, fixed size. This makes it difficult for users to view without strain. The problem is compounded when the display screen is small.

Accordingly, there is a need in the industry for a system and method for overcoming the above problems.

### SUMMARY OF THE INVENTION

The present invention relates to a home entertainment system and method for providing adaptive scaling of selected features on a screen page displayed by an entertainment system. The entertainment systems receives programming data associated with a show, and displays the programming data on a screen page. The user is then prompted to select at least one feature of the screen page for scaling and to provide a scaling factor of the at least one feature. Various embodiments are disclosed.

### BRIEF DESCRIPTION OF THE DRAWINGS

The features and advantages of the present invention will become apparent from the following detailed description in combination with the figures listed below.

FIG. 1A is an illustrative embodiment of an entertainment system utilizing the present invention.

FIG. 1B is an illustrative embodiment of the remote controller 115 of FIG. 1A.

FIG. 2A illustrates one embodiment of an electronic programming guide that implements the process of the invention.

FIG. 2B illustrates one embodiment of an options menu superimposed over the electronic programming guide of FIG. 2A, in accordance with the principles of the invention.

FIG. 2C illustrates one embodiment of the scaling menu provided upon selection of the scaling range icon of FIG. 2B.

FIG. 2D illustrates one embodiment of the scaling input window provided upon selection of the scaling range icon 254 of FIG. 2C.

FIG. 3 illustrates one embodiment of an electronic programming guide shown with a scaled feature, as provided in accordance with the principles of the invention.

FIG. 4 illustrates a detailed block diagram of one embodiment of the IRD 110 of FIG. 1A.

FIG. 5 illustrates a detailed block diagram of one embodiment of the Main Logic Block 410 of FIG. 4.

FIG. 6 is a flow chart illustrating one embodiment of the adaptive scaling process provided in accordance with the principles of the invention.

FIG. 7 is a flow chart illustrating one embodiment of the display process provided in accordance with the principles of the invention.

### DESCRIPTION OF THE PREFERRED EMBODIMENT

In one embodiment, the present invention relates to a system and method for providing adaptive scaling of selected features in an electronic guide screen provided on a digital satellite system.

Herein, various terms are used to describe certain elements or characteristics of the present invention. For example, a “communication line” is broadly defined as any communication path between a source and a destination. The communication line may include one or more information-carrying lines (electrical wire, fiber optics, cable, etc.) or wireless communications through established techniques such as infrared (IR) and radio frequency (RF) signaling. A “signal” is construed as information transmitted in a parallel or serial manner. Stored within the system, “programming data” includes information of channels chosen by the user to be entered into memory. While certain illustrative embodiments are described in order to convey the spirit and scope of the present invention, such embodiments should not be construed as a limitation on the scope of the present invention.

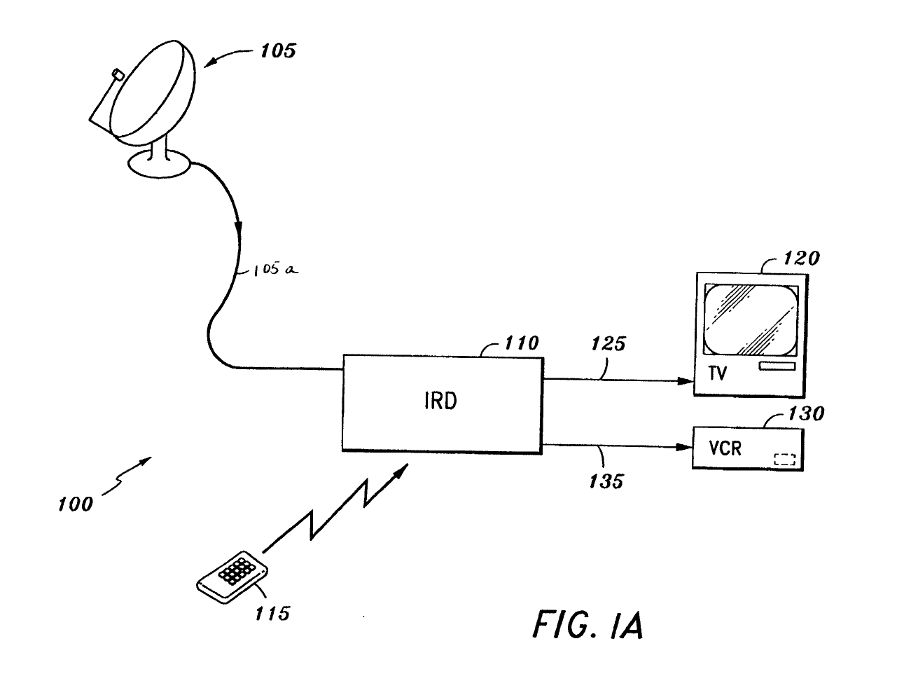

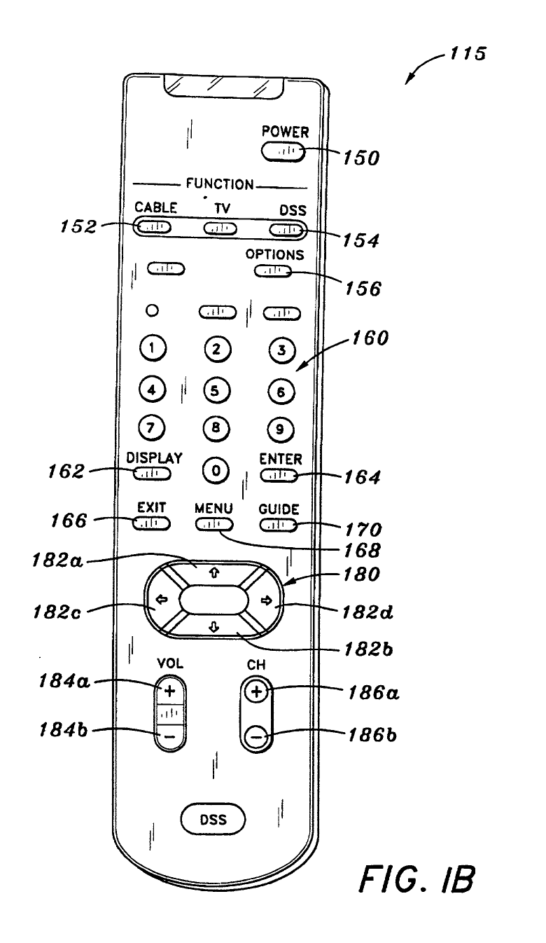

Referring to FIG. 1, one embodiment of an entertainment system utilizing the present invention is shown. The entertainment system 100 comprises an antenna 105, a broadcast receiver 110 such as an integrated receiver decoder (IRD) for example, and at least one analog-input peripheral device (e.g., a display monitor such as television receiver “TV” 120 and/or an analog recording device 130 such as a video cassette recorder “VCR”). The broadcast receiver, in general, receives a broadcast signal (a digital bit stream for example) and performs operations on the broadcast signal to produce digital and/or analog information. Although the IRD is implemented as the broadcast receiver in this embodiment, other types of broadcast receivers may be used such as a cable box for a Cable Broadcasting System, an Internet terminal, a digital satellite system (DSS) computer and the like.

Antenna 105 receives the digital bit stream from an orbiting satellite (not shown) and routes the bit stream to IRD 110. The bit stream is formatted in accordance with any video compression function and is usually encrypted under either a symmetric key cryptographic function or a public-key cryptographic function. Typically, the bit stream includes sensory data (e.g., video and/or audio, or communication data) and control information for a number of shows. The control information for each show includes programming data having the following content: date of broadcast, broadcast channel number, show start-time, show end-time, and also show title.

IRD 110 is responsible for decoding the bit stream, for storing programming data in timer memory accessible by software executed by IRD 110, and for processing the decoded bit stream to produce one or more output signals having appropriate formats. As shown, an output signal is placed in an analog format and sent via communication line 125 to TV 120 for viewing, and/or via communication line 135 to analog recording device 130 for recording. The analog format may be in accordance with a video format established by National Television Systems Committee (NTSC), or perhaps other video formats, including but is not limited or restricted to Phase Alternating Line (PAL), Sequential Couleur Avec Memoire (SECAM) and other recognized formats.

Additionally, IRD 110 is responsible for responding to a plurality of commands from a remote control 115. Remote control 115 may include any type of remote control, including one described in U.S. Pat. No. 5,453,758 assigned to Sony Corporation of Tokyo, Japan. FIG. 1B is an illustrative embodiment of the remote control 115 of FIG. 1A. The remote control 115 comprises a power key 150 for activating the IRD 110, a cable key 152 which facilitates selection of cable channels, a DSS key 154 which facilitates selection of satellite-based channels, an OPTIONS key 156 for facilitating selection of desired channels; a numerical keypad 160, a DISPLAY key, an ENTER key 164, an EXIT key 166, a MENU key 168, and a GUIDE key 170. The remote control 115 further comprises an ABXY button grid 180 (which includes scroll buttons 182 a-d), a pair of volume keys 184a, 184b, and a pair of channel selection keys 186a, 186b. In one embodiment, the ABXY button grid 180 is a video game control used by many commercially available video systems such as those made and manufactured by Nintendo of Japan.

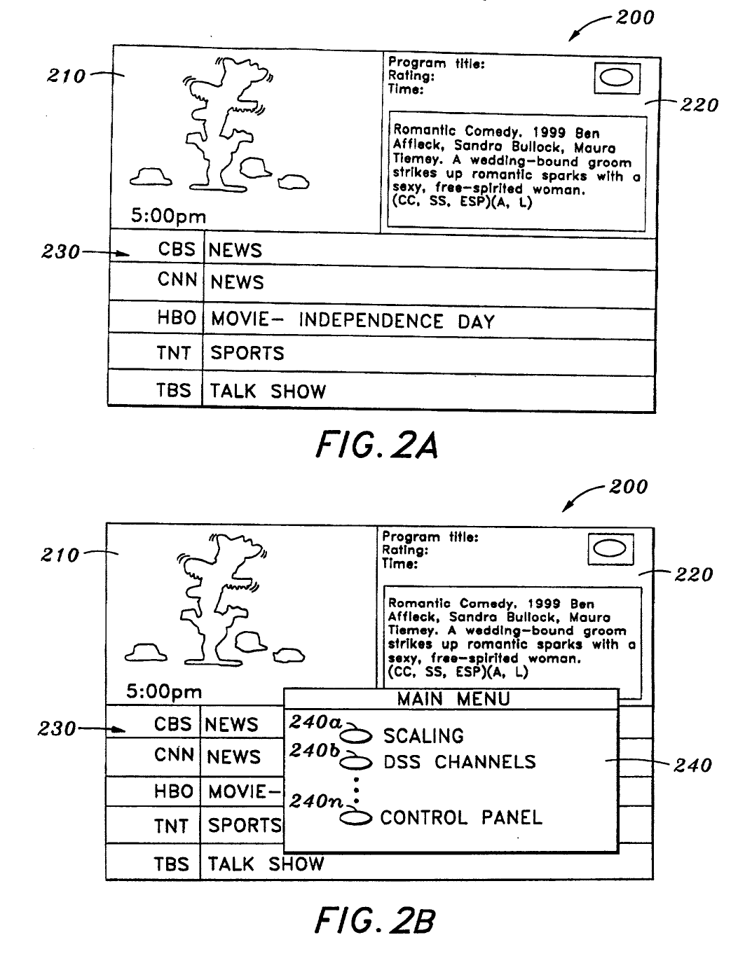

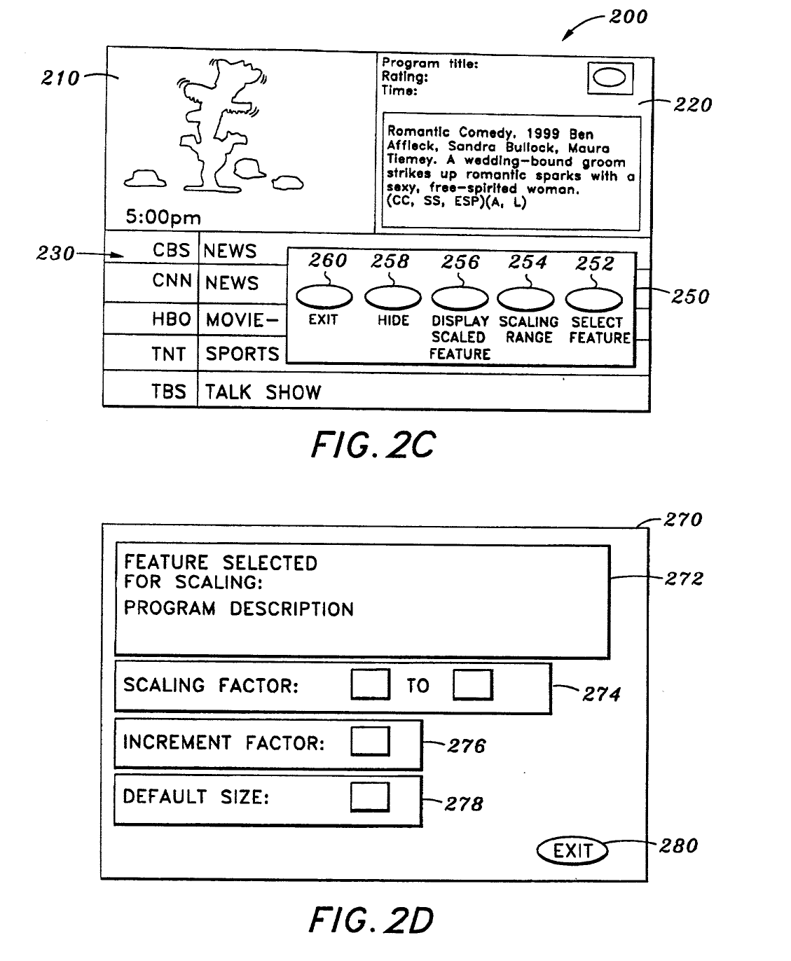

Examples of commands from remote control 115 include a first command by pressing the OPTIONS key 156, causing IRD 110 to produce an output signal displaying at least an electronic programming guide 200 on TV 120, as shown in FIG. 2A. The electronic programming guide 200 may include a graphical portion 210, a textual portion 220 and an options grid 230. The graphical portion 210 may include a sample display of a show, while the textual portion 220 may include the program title, rating, time of broadcast and a short description of the show. The options grid 230 may include a guide of the programs or shows available for viewing, along with the show times. In one embodiment, the viewer may use the channel selection buttons 186a and 186b to scroll through the shows. During scrolling, a particular show that is highlighted may be selected using the ENTER key 164. Upon such selection, a graphical representation of the show will be displayed in the graphical portion 210, while a description of the program will be provided in the textual portion 220.

Upon selection of the MENU key 156, a main menu 240 may be superimposed over the electronic programming guide 200. The main menu 240 may include a list of options for the viewer to select, which may include, in one embodiment, a scaling icon 240a, a DSS channels icon 240b, . . . , and a control panel icon 240n.

Upon selecting the scaling icon 240a, a scaling options menu 250, as shown in FIG. 2C, is displayed. In one embodiment, the scaling options menu 250 may be superimposed over the electronic programming guide 220. In one embodiment, the scaling options menu 250 comprises a number of icons, each of which can be selected to perform a function associated with the adaptive scaling of one or more features of the electronic programming guide 220. In one embodiment, the scaling options menu 250 includes a SELECT FEATURE icon 252 that the user may select to choose the feature to be scaled. Such a feature may include any portion of the electronic programming guide 220, such as the graphical portion 210, the textual portion 220 or the options grid 230. The developer may, of course, configure the software to perform scaling on any other predetermined portion of the electronic programming guide 220. In one embodiment, after selecting the SELECT FEATURE icon 252, the user may click onto any one of the selectable features, such as 210, 220, or 230, which will subsequently be highlighted, indicating that the feature is selected for scaling.

The next icon, the scaling range icon 254, may be selected to perform scaling of the selected feature. Upon selection of the scaling range icon 254, a scaling window 270 appears. The scaling window 270 may be superimposed over the electronic programming guide 200. FIG. 2D illustrates one embodiment of the scaling window 270, which comprises a first section 272 that identifies the feature selected for scaling, a second section 274 that facilitates specification of the scaling factor, a third section 276 that facilitates specification of the increments in scaling a feature, a fourth section 278 that facilitates specification of the default size of a selected feature, and an EXIT icon 280. The second section 274 enables the user to specify the scaling factor of a selected feature. In one embodiment, the scaling factor may have upper and lower limits that are preset due to system limitations or restrictions. The user can then specify his or her preferred scaling ranges. For example, the user may specify that the scaling factor is 0.5× to 3.5× (i.e., 0.5 times to 3.5 times the original or currently displayed size). The user may also specify the increment factor using the third section 276. The increment factor, when specified, enables the user to use the channel keys 186a and 186b to increase or decrease the scaling factor of a selected feature at a predetermined increment rate, such as 0.5% of the original size. In addition, the user may specify a default size, such as 1.2× or 1.2 times the original or the currently displayed size. Upon completing entry of the scaling factors, the user may select the EXIT icon 280 to exit the scaling window 270 and to return to the scaling options menu 250.

The third icon in the scaling options menu 250 is the display scaled feature icon 256, which when selected, will display the selected feature in accordance with the default size specified by the user. Upon display, the user may use the channel keys 186a or 186b to increase or decrease the size of the displayed feature.

The fourth icon in the scaling options menu 250 is the HIDE icon 258, which when selected, will hide the scaling options menu 250. To redisplay the scaling options menu 250, the user may depress the ENTER key 164 on the remote control 115. The fifth icon in the scaling options menu 250 is an EXIT icon 260, which when selected, will enable the user to exit from the scaling options menu 250.

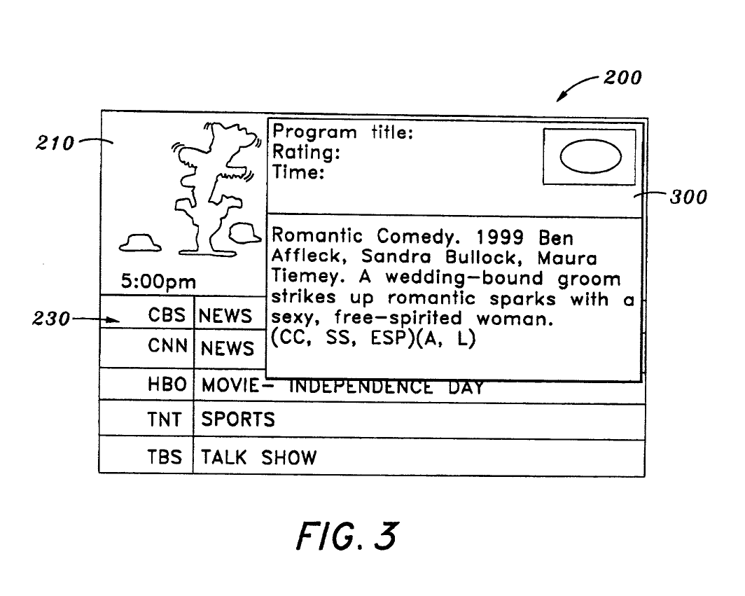

Once all the entries have been made, the user may select a feature in the electronic programming guide 200 for display at a desired size. In addition, the user may further increase or decrease the size of the selected feature, as shown in FIG. 3.

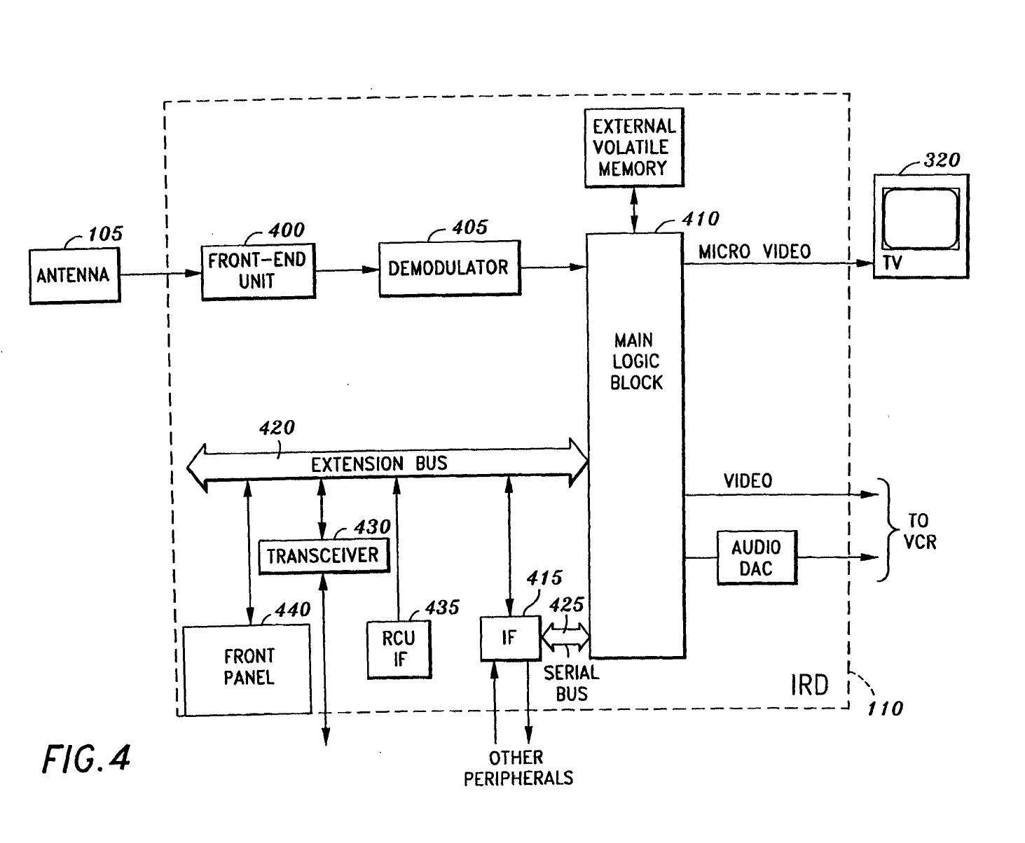

Referring now to FIG. 4, one embodiment of an integrated receiver decoder (IRD) 110 is shown. The antenna 105 transfers the bit stream to a front-end unit 400 of the IRD 110. Although not shown, the front-end unit 400 includes (i) amplification circuitry used to amplify any relatively weak signals received at antenna 105, and (ii) a tuner which allows a user to receive a desired broadcast channel.

For the case where the user wishes to view a show provided by the digital satellite system service provider, the bit stream associated with the desired broadcast channel is routed from front-end unit 400 to a demodulator 405. In demodulator 405, the bit stream is initially processed before transferring to a main logic block 410 for further processing. Such initial processing may include exposing the bit stream to QPSK-demodulation, viterbi-decoding, de-interleaving and ReedSolomon decoding.

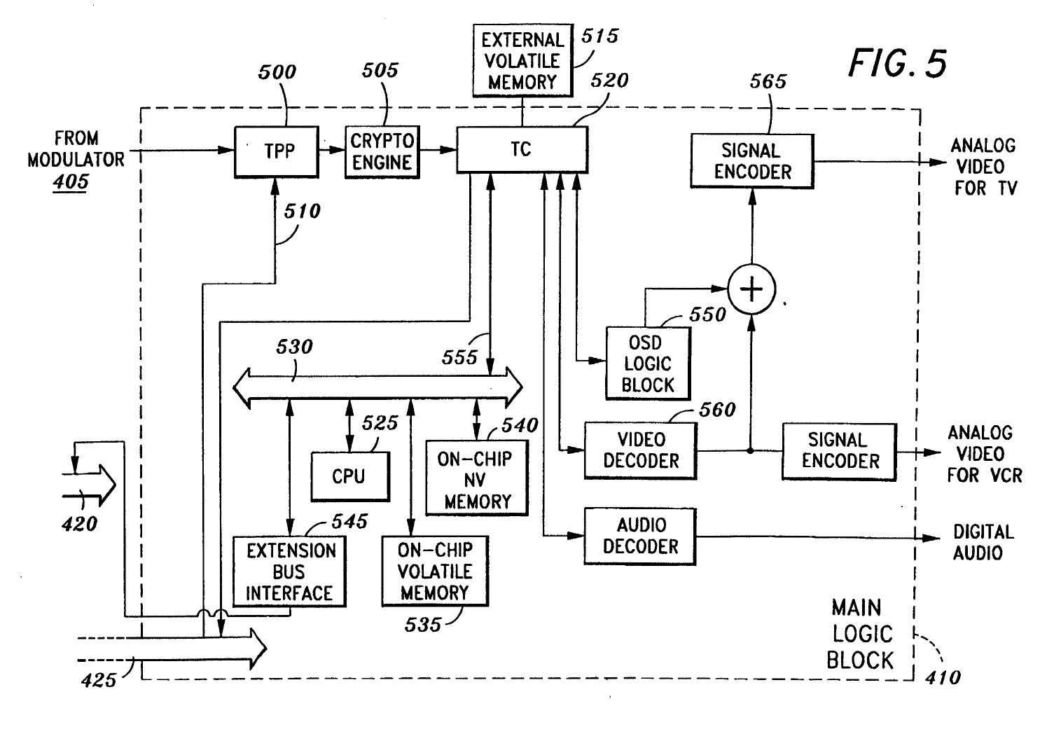

In certain situations, IRD 110 is connected to other peripheral devices though an interface (IF) 415. In this embodiment, IF 415 may include a link layer integrated circuit (IC) and a physical layer IC (not shown) and complies with the IEEE standards document 1394 entitled “Standard for High Performance Serial Bus” (hereinafter referred to as “IEEE 1394”). This enables IRD 110 to connect to digital-input peripheral devices such as digital VCRs, digital video disk players, digital laser disk players and the like. These digital-input peripheral devices communicate with a central processing unit (CPU) within main logic block 410 (see FIG. 5) through IF 415 and either extension bus 420 or alternatively an IEEE 1394 serial bus 425.

Referring still to FIG. 4, extension bus 420 supports input/output (I/O) communications by providing a communication path between electronic circuitry of the main logic block 410 and a number I/O related devices. These I/O related devices include a transceiver device 430 (e.g., a modem), a remote command unit interface (RCU-IF) 435, and a front panel 440. In one embodiment, the front panel 440 includes buttons or switches for receiving user input or commands. The buttons or switches may correspond to those on the remote controller 115 and the buttons or switches on the front panel 440 may be used to issue commands to the IRD 110 instead of the remote controller 115. RCU-IF 435 receives commands from the remote controller 115, and decodes the commands to produce interrupt request signals (IRQs) corresponding to these commands. Each IRQ is transferred to the CPU within the main logic block 410. The front panel 440 includes buttons or switches to provide user functionality and access to the system and described herein.

Referring now to FIG. 5, electronic circuitry of the main logic block 410 is shown. The Transport Packet Parser (TPP) 500 receives the decoded bit stream and parses the bit stream. This parsed bit stream is decrypted by a cryptographic engine 505 which may operate in accordance with a cryptographic function, for example Data Encryption Standard (DES). However, if the bit stream is received from IF 415 via communication line 510, cryptographic engine 505 will be precluded from decrypting the bit stream since it is already in a decrypted form. Thereafter, the decrypted bit stream, including the programming data, is stored in an external volatile memory 515 (e.g., random access memory “RAM”) under the control of traffic controller (TC) 520.

CPU 525 controls the operations of the IRD by communicating with a plurality of elements through an internal high-speed bus 530. These elements include an optional volatile memory 535, at least one non-volatile (NV) memory element 540 (e.g., read only memory “ROM”, erasable programmable read only memory “EPROM”, flash memory, etc.) to contain software programs, extension bus interface 545, and traffic controller 520. NV memory element 540, in lieu of external NV memory 445 of FIG. 4, may be used to store software needed by CPU 525 (e.g., interrupt software) or perhaps stored channel data. Extension bus interface 545 allows CPU 525 to communicate with the devices coupled to extension bus 420.

Referring to FIGS. 4-5, the operations performed by IRD 110 to support adaptive scaling of selected features are described. Upon receiving the first command from the remote control (e.g., user depressing “GUIDE” key 170 of remote control), RCU-IF 435 transfers a first interrupt request signal (IRQ1), corresponding to the first command, directly to CPU 525 or indirectly through a queuing mechanism (not shown). In response to detecting IRQ1, CPU 525 executes interrupt software contained in external NV memory element 445 (or NV memory element 540) and services IRQ1. More specifically, in order to service IRQ1, CPU 525 executes interrupt software, normally coded to control an on-screen display (OSD) logic block 550, to produce the electronic programming guide 200 (see FIG. 2A).

The CPU 525 also retrieves least programming data contained in external volatile memory 515 and route the programming data to OSD logic block 550. Next, CPU 525 controls OSD logic block 550 to decompress the programming data in accordance with a recognized video format and to produce (for display) the electronic programming guide 200 (see FIG. 2A) in a manner well-known in the art. In general, the programming data is processed as a bitmap to overlay appropriate grids forming the layout of the electronic programming guide 200.

The electronic programming guide 200 may be superimposed over video by mixing the electronic bookmark guide 200 with video output from video decoder 560. The video output is video received by main logic block 410 and decompressed in accordance with Moving Picture Experts Group (MPEG), Joint Picture Experts Group (JPEG) or any other video decompression function. The resulting mixed video output is transferred to signal encoder 565. Signal encoder 565 converts the mixed video output into an analog signal having a recognized video format such as NTSC, PAL, SECAM and the like.

Upon receiving the second command from the remote control (e.g., user selecting the MENU key 168 of remote control 115), RCU-IF 435 transfers a second interrupt request signal (IRQ2), corresponding to the second command, directly to CPU 525 or indirectly through a queuing mechanism (not shown). In response to detecting IRQ2, CPU 525 executes interrupt software contained in external NV memory element 445 (or NV memory element 540) and services IRQ2. In one embodiment, the CPU 525 signals traffic controller 520, via communication line 555, to display the main menu 240 (see FIG. 2B). The user may select the scaling icon 240a to specify scaling of a selected feature.

In one embodiment, selection of the icons may be entered by using the left and right scroll buttons 182c-d on the ABXY button grid 380 of the remote control 115. Alternatively, selection of the icons may be entered by using the channel keys 186a, b or volume control keys 184a, b.

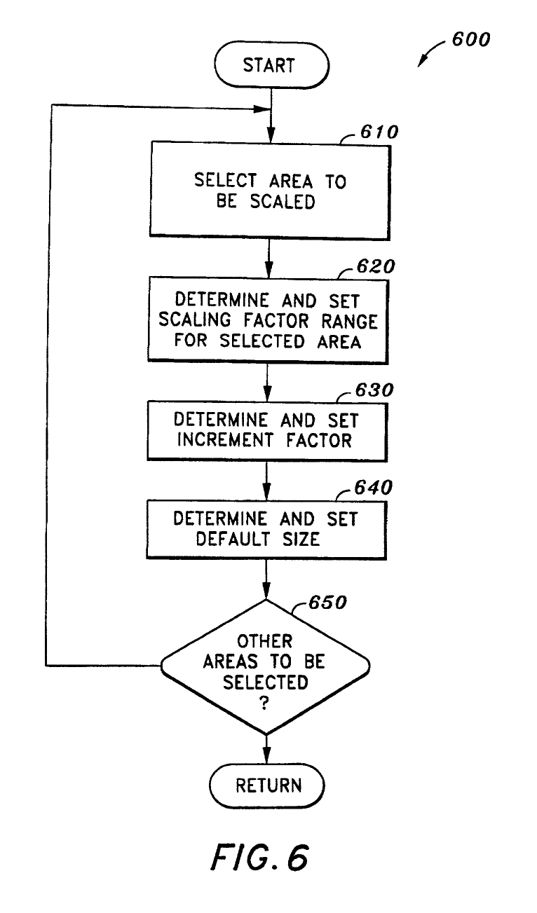

FIG. 6 is a flow chart illustrating one embodiment of the adaptive scaling process provided in accordance with the principles of the invention. Beginning from a START state, the process 600 proceeds to process block 610, where it prompts the user to select the area or feature to be scaled. The features that may be scaled will be highlighted one at a time, and the user may scroll through the scaleable features using the ABXY buttons 182a-d, the channel keys 186a,b or the volume control keys 184a,b. To select a feature for scaling, the user has to scroll to the desired feature and depress the ENTER key 164. Upon such selection, the process 600 proceeds to process block 620, where it prompts the user to determine and set the scaling factor range for the selected area or feature. The user may enter the desired scaling range as described earlier, and the process 600 will then proceed to process block 630, where the process 600 prompts the user to determine and set the increment factor for the selected feature. Once entered, the process 600 advances to process block 640, where it prompts the user to determine and set the default size. Next, the process 600 determines if there are other areas or features that are selected for scaling. If so, the process 600 returns to process block 610. Otherwise, it terminates and returns to the main program.

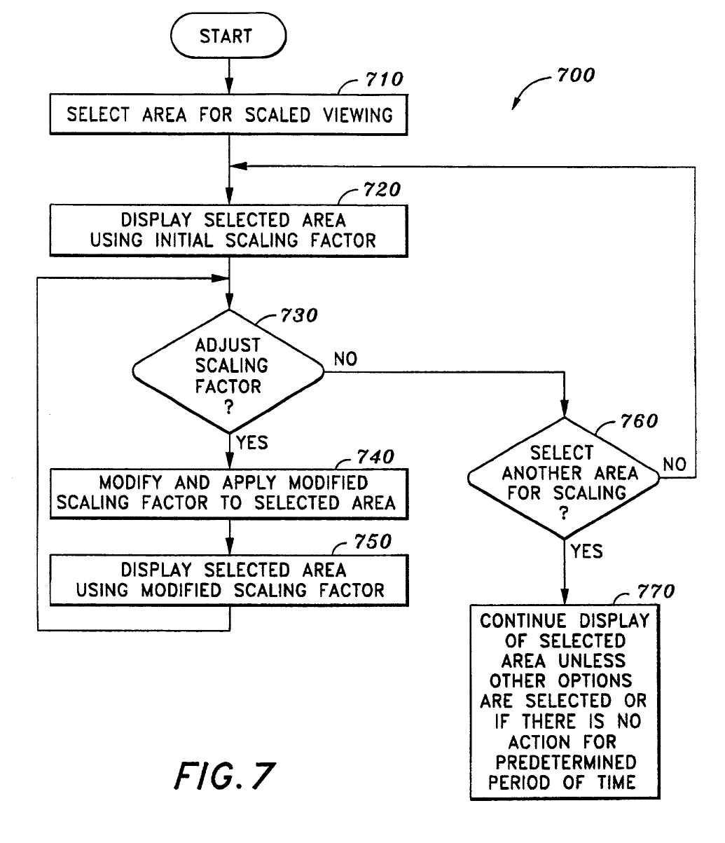

FIG. 7 is a flow chart illustrating one embodiment of the display process provided in accordance with the principles of the invention. Once the scaling factors for one or more features has been determined, the user may implement the adaptive scaling process during display of various features. Beginning from a START state, the process 700 proceeds to process block 710, where the user selects an area or feature for scaled viewing. The process 700 displays the selected area using the initial scaling factor or default size previously specified (process block 720). Next, the process 700 determines if the user has adjusted the scaling factor by monitoring if he or she has depressed the keys designated for increase or decrease of the scaled feature size. If so, the process 700 proceeds to process block 740, where it modifies and applies the new or modified scaling factor to the selected area. The selected area is then displayed using the modified scaling factor, as shown in process block 750, and the process returns to decision block 730. If, at decision block 730, the process 700 determines that the scaling factor has not been adjusted, the process 700 proceeds to decision block 760, where it determines if the user has selected another area for scaled viewing. If so, the process 700 proceeds to process block 720. Otherwise, it proceeds to process block 770, where it continues display of the selected area unless other options are selected or if there is no action for a predetermined period of time. In the latter situation, the process 700 returns to displaying the electronic programming guide 200 using its default size.

It is contemplated that the invention may be implemented for use in display systems other than that provided using an IRD 110. Moreover, the invention may be implemented in a television system, an in-flight entertainment system, or a computer network system (any other systems?). It may be used to quickly and conveniently scale a selected area or feature for subsequent display. During display of the scaled feature, the user may proceed to scale the selected feature to obtain a desirable size for viewing.

Through the implementation of the present invention, one or more selected features in an electronic programming guide may be scaled and displayed. As a result, viewing of an area or feature at a desired size may be provided without substantial user interaction.

The present invention described herein may be designed in many different embodiments and using many different configurations. While the present invention has been described in terms of various embodiments, other embodiments may come to mind to those skilled in the art without departing from the spirit and scope of the present invention. The invention should, therefore, be measured in terms of the claims which follow.

What is claimed is:

1. A method for providing adaptive scaling of selected features on a screen page displayed by an entertainment system, comprising:
receiving programming data associated with a show;
displaying the programming data on a screen page;
selecting at least one feature of the screen page for scaling;
providing a scaling factor of the at least one feature.

2. The method of claim 1, further comprising displaying the scaled feature.

3. The method of claim 1, wherein providing a scaling factor includes providing a range.

4. The method of claim 1, wherein providing a scaling factor includes providing a default scaling factor.

5. The method of claim 1, further comprising providing an increment factor that is used to increase a size of the at least one feature beyond the scaling factor.

6. The method of claim 1, wherein displaying the programming data includes:
executing software by a central processing unit, implemented within the entertainment system, to produce a screen menu and a program description.

7. The method of claim 6, wherein selecting the at least one feature of the screen page for scaling includes:
selecting at least one of said screen menu and said program description.

8. The method of claim 1, further comprising displaying a menu having a plurality of icons, one of said icons being selectable to scale of the selected feature.

9. The method of claim 8, wherein a second one of said icons is selectable to provide the scaling factor.

10. The method of claim 8, wherein a second one of said icons is selectable for displaying the scaled feature.

11. An entertainment system comprising:
a display monitor; and
a broadcast receiver coupled to the display monitor, the broadcast receiver including
a front-end unit capable of receiving programming data associated with a show broadcast for viewing on the display monitor,
a memory that stores instruction sequences, and
a central processing unit coupled to the memory, the central processing unit receiving programming data associated with a show, said central processing unit executing said instruction sequences to: display the programming data on a screen page, prompt selection of at least one feature of the screen page for scaling, and to prompt selection of a scaling factor for the at least one feature.

12. The entertainment system of claim 11, wherein said central processing unit displays the scaled feature in response to a user instruction.

13. The entertainment system of claim 11, wherein said scaling factor includes a range.

14. The entertainment system of claim 11, wherein said scaling factor is a a default scaling factor.

15. The entertainment system of claim 11, wherein said central processing unit further prompts entry of an increment factor that is used to increase a size of the at least one feature beyond the scaling factor.

16. The entertainment system of claim 11, wherein the programming data is displayed on a screen menu and a program description.

17. The entertainment system of claim 16, wherein said feature is one of said screen menu and said program description.

18. The entertainment system of claim 11, wherein said central processing unit further displays a menu having a plurality of icons, one of said icons being selectable to scale of the selected feature.

19. The entertainment system of claim 18, wherein a second one of said icons is selectable to provide the scaling factor.

20. The entertainment system of claim 18, wherein a second one of said icons is selectable for displaying the scaled feature.
